(19) United States
(12) Patent Application Publication
(10) Pub. No.: US 2003/0121693 A1
(43) Pub. Date: Jul. 3, 2003

(54) Aerial cable

(76) Inventors: Andreas Stingl, Kronach (DE); Frank Koschwitz, Rodental (DE); Greiner Ulrich, Neustadt (DE); Reinhard Engel, Grub am Forst (DE); Sabine Will, Neustadt (DE); Alois Weiss, Untersiemau (DE)

Correspondence Address: CORNING CABLE SYSTEMS LLC, P O BOX 489, HICKORY, NC, 28603, US

(21) Appl. No.: 10/261,983

(22) Filed: Oct. 1, 2002

(30) Foreign Application Priority Data
Oct. 2, 2001 (DE) 20116209.1

(51) Int. Cl. H01B 7/00

(52) U.S. Cl. 174/70 A

(57) ABSTRACT

An aerial cable with a surface of especially plastic or metal, the aerial cable having devices integrated into the surface for minimizing turbulent eddy currents. The devices being operative to provide the surface of the aerial cable with a flow optimized structure. The devices being formed as integrated notches, grooves, and/or dents.

### FIELD OF THE INVENTION

The invention concerns fiber optic aerial cables and, more particularly, to aerial cables having reduced windage effects.

### BACKGROUND OF THE INVENTION

Aerial cables, which are fastened to poles or overland long distance lines, are subjected to free wind flow due to their exposed position. During wind flow turbulent eddy currents occur, which stress the aerial cable mechanically. Due to the wind flow, vibrations—so-called aeolian vibrations—can occur at the aerial cable, which also stress the aerial cable mechanically. These mechanical stresses can, for example, lead to a fatigue break of the cable and thus influence the useful life and reliability of the aerial cable negatively.

To minimize the mechanical stress on the aerial cable due to wind flow, oscillation stabilizers, for example, so-called Stockbridge stabilizers, are installed at the aerial cable according to the state of the art. However, providing of such separate oscillation stabilizers increases the installation cost of the aerial cable.

Proceeding from this, the invention has the objective to create a new type of aerial cable.

### SUMMARY OF THE INVENTION

The foregoing problem is solved by an aerial cable according to the present invention with a surface of especially plastic or metal, having devices integrated into the surface for minimizing turbulent eddy currents.

With the aerial cable according to the invention the mechanical stresses on the aerial cable are minimized. Additionally, the oscillations of the aerial cable due to free wind flow are decreased. This increases the useful life of the aerial cable and the oscillation stabilizer attached to the aerial cable can be eliminated. The installation of the aerial cable becomes much more cost effective.

Preferred further developments of the invention are seen in the sub claims and the following description. Construction examples are explained in detail by means of diagrams.

### BRIEF DESCRIPTION OF THE DRAWING FIGURES

FIG. 1 shows an aerial cable according to the invention according to the first construction sample of the invention in a side view in perspective.

FIG. 2 shows a cross-section of the aerial cable according to FIG. 1.

FIG. 3 shows an aerial cable according to the invention according to a second construction sample also in a side view in perspective.

### DETAILED DESCRIPTION OF THE INVENTION

Aerial cables are fastened to poles of overland long distance lines, and due to their exposed position are subject to free wind flow.

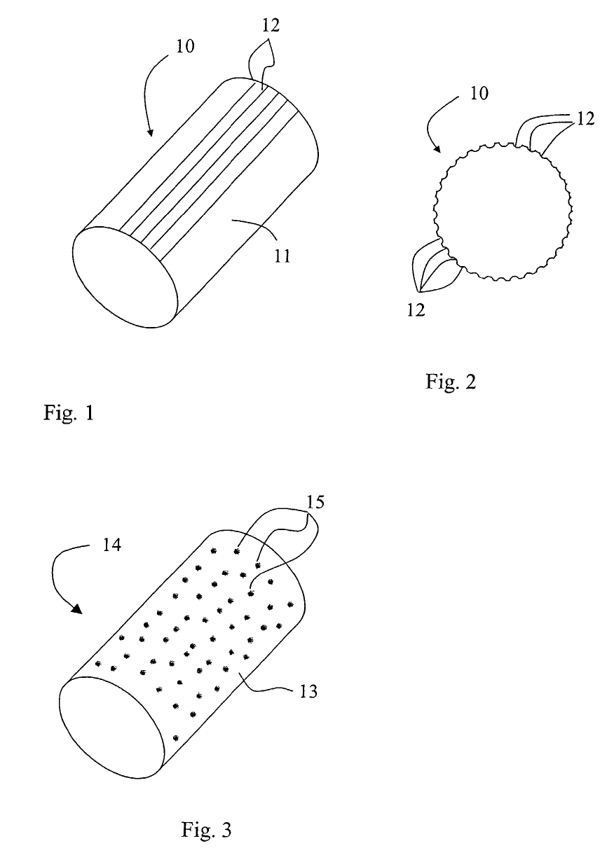

According to the invention, devices for minimizing turbulent eddy currents are integrated into the surface of the aerial cable The construction sample according to FIGS. 1 and 2 show an aerial cable 10, into whose surface 11 notches, namely grooves 12, are integrated stretching in the longitudinal direction of the aerial cable 10. The grooves 12 are located at equal distances from each other and give a flow optimized structure to the aerial cable 10 or its surface 11, respectively. The grooves 12 can stretch parallel to the longitudinal direction of the aerial cable 10 or can be arranged in a spiral or helically on the surface 11.

According to the construction sample in FIG. 3, notches formed as dents 15 are added to the surface 13 of an aerial cable 14, which give the aerial cable 14 a flow optimized structure. The dents 15 integrated in the surface 13 preferably form an even pattern on the surface 13. In this way, the surface structure 13 of the aerial cable 10 can resemble the surface structure of a golf ball.

With the aerial cables according to the invention, the mechanical stresses on the aerial cable due to free wind flow are minimized. A defined structure is impressed onto the surface of the aerial cable according to the invention. According to flow technology, this structure on the surface of the aerial cable prevents the formation of a laminar boundary layer and thus the formation of turbulent drag. A controlled turbulent flow of the aerial cable according to the invention is achieved instead. The surface of the aerial cable according to the invention therefore has optimized circulating flow. In this way the oscillations of the aerial cable due to free wind flow are decreased. This increases the useful life of the aerial cable and the oscillation stabilizer on the aerial cable can be eliminated. The installation of the aerial cable becomes more cost effective.

1. Aerial cable with a surface of especially plastic or metal, said aerial cable comprising devices being integrated into the surface for minimizing turbulent eddy currents.

2. The aerial cable according to claim 1, the devices giving the surface of the aerial cable a flow optimized structure.

3. The aerial cable according to claim 1, the devices being formed as integrated notches into the surface of the aerial cable.

4. The aerial cable according to claim 3, the notches being formed into grooves stretching in the longitudinal direction of the aerial cable.

5. The aerial cable according to claim 3, the notches being formed as dents.
